(19) United States
(12) Patent Application Publication
(10) Pub. No.: US 2026/0164310 A2
(43) Pub. Date: Jun. 11, 2026

(54) S1G DUPLICATE MODE CLASSIFICATION METHODS AND WIRELESS COMMUNICATION DEVICES IN A WIRELESS NETWORK

(71) Applicant: Morse Micro Pty. Ltd., Surry Hills NSW (AU)

(72) Inventors: Surendra Raju Meesaraganda, Bangalore (IN); Gelyn Replan Manzanares, Sydney (AU)

(21) Appl. No.: 19/261,744

(22) Filed: Jul. 7, 2025

Related U.S. Application Data
(63) Continuation-in-part of application No. 19/090,246, filed on Mar. 25, 2025.

(30) Foreign Application Priority Data
Jul. 15, 2024 (AU) 2024902179

(51) Int. Cl. H04W 28/20; H04L 5/00; H04L 27/00; H04W 72/0446

(52) U.S. Cl. CPC H04W 28/20; H04L 5/0048; H04L 27/0014; H04W 72/0446; H04L 2027/0057

(57) ABSTRACT

Methods and wireless communication devices for mode classification include configuring the wireless communication device to receive a wireless frame transmitted over an operating channel bandwidth, determine a frequency domain signal representing a plurality of symbols carried in the wireless frame, estimate a primary channel bandwidth for the wireless frame from the frequency domain signal, determine a bandwidth field in a signal field of the wireless frame, compare the primary channel bandwidth with the operating channel bandwidth, and a mode used to transmit the wireless frame based on the bandwidth field and the comparing result.

### CROSS-REFERENCE TO RELATED APPLICATION

This application is a continuation-in-part of U.S. patent application Ser. No. 19/090,246, filed on 25 Mar. 2025, which claims priority from Australian provisional patent application number 2024902179, filed 15 Jul. 2024, which are incorporated herein by reference in their entirety.

### FIELD OF THE INVENTION

The present disclosure generally relates to wireless communications. Specifically, aspects of the present disclosure are related to mode classification methods for wireless reception.

### BACKGROUND

A wireless communication network, such as a Wireless Local Area Network (WLAN), operates in compliance with one or more IEEE 802.11 wireless protocol standards, typically includes multiple wireless communication devices. A Basic Service Set (BSS) in a wireless communication network includes at least an Access Point (AP) communicating with one or more Stations (STAs). In general, an AP serves as a hub for the WLAN, while an STA functions as a client device that connects to the AP via a wireless protocol-compliant link to obtain network connectivity. The AP of the wireless communication network may be coupled to another network, such as the Internet, and may enable STAs to communicate bi-directionally or enable a STA to communicate with other devices in the network through the AP. A wireless device includes a transmitter configured to transmit packets or data units carried in a wireless signal, and a receiver configured to receive packets or data units carried in a wireless signal. The receiver comprises an amplifier that amplifies the wireless signal and an Automatic Gain Control (AGC) mechanism that adjusts the gain of the amplifier. In the receiving path, an analog-to-digital converter (ADC) is configured to convert the amplified wireless signal into a digital representation. The wireless signal may be filtered and down-sampled before being converted into the digital representation. A transform module, such as a Fast Fourier Transform (FFT) module, is configured to convert the representation of the wireless signal into a frequency spectrum. The receiving path may further include a channel estimator and an equalizer, which together estimate the characteristics of the channel over which the data unit is received and then remove certain channel effects based on the channel estimation to generate equalized data. For example, the channel estimator and equalizer estimate the channel using information from one or more received training fields, such as the Long Training Field (LTF).

In the receiving path, a demodulator is configured to demodulate the equalized data. Examples of demodulators include Quadrature Amplitude Modulation (QAM) demodulators, Quadrature Phase-Shift Keying (QPSK) demodulators, and Binary Phase-Shift Keying (BPSK) demodulators. Data units exchanged between the AP and the STA may include control information or data. At the Physical (PHY) layer, these data units are referred to as Physical Layer Protocol Data Units (PPDUs), each of which may comprise a preamble and a payload. The preamble may include training fields and a SIG field, while the payload may contain a Media Access Control (MAC) header and/or user data. The preamble helps intended receivers detect incoming signals and establish initial synchronization. Designed with repeated symbol patterns that exhibit strong correlation properties, preambles allow the receiver to easily identify the start of a packet. Once a signal is received, the receiver converts it into a stream of discrete-time complex baseband samples. It then applies correlation-based algorithms to detect the initial samples of each incoming packet. The initial synchronization process generally consists of packet detection, sampling time offset estimation, and Carrier Frequency Offset (CFO) estimation.

A wireless signal transmitted using Orthogonal Frequency Division Multiplexing (OFDM) relies on a number of orthogonal subcarriers for transmission. A wireless device transmits and receives messages using various numbers of subcarriers. The number of subcarriers used by the wireless device may depend on the available frequency bands, the available bandwidth, and any regulatory constraints. The IEEE 802.11ah standard introduces the concept of primary and secondary (or non-primary) channels to further divide airtime between available channels. The primary channel is the channel used to transmit frames at its native bandwidth. The concept of subbands allows for flexible and adaptive use of the available spectrum. The channel bandwidth can be dynamically selected on a per-frame basis to allow more efficient utilization of the spectrum. A wireless device transmits at a higher data rate when a wide channel is available and can fall back to a lower data rate when only a narrow channel is available. The term subband is used to define a 1 MHz, 2 MHz, 4 MHz, 8 MHz, or 16 MHz sub-1 GHz (S1G) operating channel. A subband may support both primary and secondary channels. For example, in a 2, 4, 8, or 16 MHz subband, the 1 MHz channel used to transmit 1 MHz PHY Protocol Data Units (PPDUs) is referred to as the primary 1 MHz channel. In a 2 MHz subband, the 1 MHz channel adjacent to the primary 1 MHz channel that, together with the primary 1 MHz channel, forms the 2 MHz channel of the 2 MHz subband is referred to as a secondary 1 MHz channel. In a 4, 8, or 16 MHz subband, the secondary 1 MHz channel is the 1 MHz channel adjacent to the primary 1 MHz channel, which together form the primary 2 MHz channel of the 4, 8, or 16 MHz subband.

It may be beneficial to transmit duplicate (DUP) frames in wireless communication under some circumstances. A DUP frame is a frame composed of a number of identical frequency segments. DUP frames may be useful for clearing a wireless medium, allowing a wireless device to transmit without interference from other wireless devices transmitting simultaneously. Additionally, low-bandwidth devices may only be able to receive messages on a portion of the total bandwidth used by an AP and other wireless devices. Therefore, transmitting messages using a DUP frame is beneficial for these low-bandwidth devices. For example, a message may be transmitted by sending DUP frames on each 1 MHz portion of a 2 MHz available bandwidth. The DUP frames ensure that each low-power 1 MHz device can receive the message, regardless of which 1 MHz portion of the 2 MHz bandwidth the low-power device is using. The IEEE 802.11ah standard has adopted 1 MHz and 2 MHz DUP frame formats, where a DUP frame is made up of a number of identical 1 MHz or 2 MHz frequency segment portions. A duplicate mode transmits either a 1 MHz or 2 MHz duplicate signal in the 1 MHz or 2 MHz secondary channel, where a phase shift is applied to the tones of the duplicate signal to reduce the overall Peak-to-Average Power Ratio (PAPR) and minimize transmitter spectral regrowth. In this case, both secondary and primary correlators, for either 1 MHz or 2 MHz cases, receive similar signals, making the peaks indistinguishable. This behavior is desired, as the intended use case is to indicate that both channels are busy without introducing additional complications.

### SUMMARY

The following summary presents technical features relating to one or more aspects of low-cost kernel implementation for packet detection disclosed herein and should not be considered as an extensive overview relating to all contemplated aspects. Accordingly, the following summary has the sole purpose to present certain concepts relating to one or more embodiments relating to packet detection disclosed herein in a simplified form to precede the detailed description presented below.

Disclosed are embodiments of mode classification methods performed by a wireless communication device operating in a wireless network. The mode classification method involves receiving a wireless frame transmitted over an operating channel bandwidth, determining a frequency domain signal that represents symbols carried in the wireless frame, estimating a primary channel bandwidth for the wireless frame from the frequency domain signal, determining a bandwidth field in a signal field (SIG) of the wireless frame, comparing the primary channel bandwidth with the operating channel bandwidth, and determining a mode used to transmit the wireless frame based on the bandwidth field and the comparing result. The wireless frame is processed according to the determined mode.

In some embodiments, the mode is determined from a non-duplicate subband mode, a non-duplicate full band mode, a duplicate subband mode, and a duplicate full band mode. The mode classification method further comprises comparing the primary channel bandwidth with 2 MHz. The mode is determined to be the duplicate subband mode or the duplicate full band mode when the primary channel bandwidth is greater than 2 MHz, otherwise the mode is determined to be the non-duplicate subband mode or the non-duplicate full band mode. For example, the mode is determined to be the duplicate subband mode when the primary channel bandwidth is greater than 2 MHz but not equal to the operating channel bandwidth, the mode is determined to be the duplicate full band mode when the primary channel bandwidth is greater than 2 MHz and is equal to the operating channel bandwidth, the mode is determined to be the non-duplicate subband mode when the primary channel bandwidth is not greater than 2 MHz and is not equal to the operating channel bandwidth, and the mode is determined to be the non-duplicate full band mode when the primary channel bandwidth is not greater than 2 MHz but is equal to the operating channel bandwidth. For example, the mode is determined to be the non-duplicate subband mode when the primary channel bandwidth is equal to 2 MHz but not equal to the operating channel bandwidth, and the mode is determined to be the non-duplicate full band mode when both the primary channel bandwidth and operating channel bandwidth are equal to 2 MHz. In some embodiments, the bandwidth field in the signal field is non-zero, indicating the mode is one of the non-duplicate modes. For example, the mode is determined to be the non-duplicate subband mode when the primary channel bandwidth is not equal to the operating channel bandwidth, and the mode is determined to be the non-duplicate full band mode when the primary channel bandwidth is equal to the operating channel bandwidth.

Some embodiments of determining a frequency domain signal include transforming Long Training Field (LTF) symbols from a time domain to a frequency domain based on a Fast Fourier Transform (FFT). In one embodiment, the mode classification method further computes an average of FFT outputs of the LTF symbols and calculates magnitudes of the frequency domain signal using the average of the FFT outputs. In another embodiment, the magnitudes of the frequency domain signal are absolute values of the FFT output of the LTF symbols. For example, to calculate the magnitudes of the frequency domain signal, the magnitude of each complex number I+jQ is approximated by summing an absolute value of I, an absolute value of Q, and a half of a difference between the two absolute values. I represents an in-phase component of the complex number and Q represents a quadrature phase component of the complex number. Embodiments of estimating a primary channel bandwidth include calculating magnitudes of the frequency domain signal, computing energy levels corresponding to a plurality of subbands in the operating channel bandwidth, comparing the energy levels with a threshold, and estimating the primary channel bandwidth according to a number of consecutive subbands with energy levels exceeding the threshold.

An embodiment of computing energy levels includes estimating an energy level for each subband by summing absolute values of sub-carriers forming the subband. In another embodiment, computing energy levels includes estimating an energy level for each subband by summing squared absolute values of sub-carriers forming the subband. The mode classification method further includes determining a subband index of a lowest subband with an energy level exceeding the threshold according to an embodiment.

The mode classification method includes checking if subband indices of subbands with energy levels exceeding the threshold are consecutive according to some embodiments. In cases when each of the subbands is 1 MHz, the primary channel bandwidth is 1 MHz when there is only one subband with an energy level exceeding the threshold, and the primary channel bandwidth is equal to 1 MHz multiplying the number of consecutive subbands when there are two or more consecutive subbands with energy levels exceeding the threshold. In cases when each of the subbands is 2 MHz, the primary channel bandwidth is 2 MHz when there is only one subband with an energy level exceeding the threshold, and the primary channel bandwidth is equal to 2 MHz multiplying the number of consecutive subbands when there are two or more consecutive subbands with energy level exceeding the threshold.

Some embodiments store two sets of channel estimates, one set assuming a duplicate 2 MHz full band mode signal and another set assuming a non-duplicate full band mode signal, and the mode classification method further comprises selecting one set of channel estimates based on the determined mode to decode payload of the wireless frame. In an embodiment, the method further comprises reconfiguring a demodulator to operate in a duplicate mode when the determined mode is a duplicate full band mode or a duplicate subband mode. In cases where the determined mode is a subband mode, the method further selects subcarriers from the selected set of channel estimates based on the primary channel bandwidth and a subband index.

In an aspect of the present invention, a wireless communication device operating in a wireless network includes at least a Radio Frequency (RF) receiver, a processor, and one or more memory bank communicatively coupled to the processor and storing processor readable codes. The RF receiver receives a wireless frame transmitted over an operating channel bandwidth. The processor executes the codes stored in the memory banks to configure the wireless communication device to determine a frequency domain signal representing symbols carried in the wireless frame, estimate a primary channel bandwidth for the wireless frame from the frequency domain signal, determine a bandwidth field in a signal field of the wireless frame, compare the primary channel bandwidth with the operating channel bandwidth, and determine a mode used to transmit the wireless frame based on the bandwidth field and the comparing result. The wireless communication device comprises a demodulator, and the demodulator is configured according to the determined mode, for example, the demodulator is configured to operate in a duplicate mode when the determined mode is a duplicate full band mode or a duplicate subband mode.

Other objects and advantages associated with the aspects disclosed herein will be apparent to those skilled in art based on the accompanying drawings and detailed description.

### BRIEF DESCRIPTION OF THE DRAWINGS

Illustrative aspects of the present application are described in detail below with reference to the following drawing figures:

FIG. 1 illustrates possible transmission channels allocated with each channel bandwidth allowed within an 8 MHz subband, 4 MHz subband, and 2 MHz subband.

FIG. 2 is a flowchart illustrating a mode classification method capable of distinguishing duplicate and non-duplicate modes according to an embodiment of the present invention.

FIG. 3 illustrates an algorithm of determining a primary channel bandwidth and a primary subband index from a frequency domain signal in accordance with an embodiment of the present invention.

FIG. 4 is a flowchart illustrating a mode classification method involving energy classification and signal field decoding according to an embodiment of the present invention.

FIG. 5 illustrates an algorithm of determining a primary channel bandwidth and a primary subband index from a frequency domain signal for duplicate 2 MHz modes in accordance with another embodiment of the present invention.

FIG. 6 illustrates a syntax structure of a signal field (SIG) carried in a wireless frame.

FIG. 7 is an exemplary high-level block diagram of a wireless communication device performing a mode classification method according to an embodiment of the present invention.

FIG. 8 is a schematic block diagram of a receiver data flow architecture in the wireless communication device of FIG. 7 for receiving wireless frames over a wireless medium.

### DETAILED DESCRIPTION

Certain aspects and embodiments of this disclosure are provided below. Some of these embodiments may be applied independently and some of them may be applied in conjunction as would be apparent to those of skill in the art. In the following description, for the purposes of explanation, specific details are set forth to provide a thorough understanding of aspects of the application. However, it will be apparent that various embodiments may be practiced without these specific details. The figures and description are not intended to be restrictive. The following description of the embodiments will provide those skilled in the art with an enabling description for implementing an example aspect. Changes may be made in the function and arrangement of elements without departing from the spirit and scope of the application as set forth in the claims.

A wireless device supporting the IEEE 802.11ah standard selects a transmission mode from full-band modes, duplicate modes, subband modes, and duplicate-in-subband modes. The duplicate modes include DUP_1M in 2 MHz, DUP_1M in 4 MHz, DUP_1M in 8 MHz, DUP_2M in 4 MHz, and DUP_2M in 8 MHz. The subband modes include 1 in 2 MHz, 1 in 4 MHz, 1 in 8 MHz, 2 in 4 MHz, 2 in 8 MHz, and 4 in 8 MHz. The duplicate-in-subband modes include DUP_1M in 2 in 4 MHz, DUP_1M in 2 in 8 MHz, DUP_1M in 4 in 8 MHz, and DUP_2M in 4 in 8 MHz. The operating channel bandwidth is the same as the primary channel bandwidth for all duplicate modes. For example, in the DUP_2M in 4 MHz mode, both the operating channel bandwidth and the primary channel bandwidth are 4 MHz. However, in subband modes, the operating channel bandwidth can be wider than the primary channel bandwidth. For instance, in the 2 in 4 MHz mode, the operating channel bandwidth is 4 MHz, while the primary channel bandwidth is 2 MHz. Similarly, in the DUP_1M in 2 in 8 MHz mode, the operating channel bandwidth is 8 MHz, while the primary channel bandwidth is 2 MHz. For subband modes and duplicate-in-subband modes, a primary 1 MHz channel index is used to indicate which channel within the subband is used for transmission.

Embodiments of a wireless device implementing a mode classification algorithm to distinguish a signal transmitted in a duplicate mode from a full-band mode, subband mode, or duplicate-in-subband mode. This mode classification algorithm allows the device to properly set parameters for receiving frames carried in the signal. For example, some of the key parameters required to decode duplicate modes, subband modes, and duplicate-in-subband modes, as specified in the IEEE 802.11ah standard, include operating channel bandwidth, primary channel bandwidth, primary 1 MHz index, transmission format, and Modulation and Coding Scheme (MCS) type. For a subband mode with a maximum operating channel bandwidth of 8 MHz, the operating channel bandwidth can be 2 MHz, 4 MHz, or 8 MHz, while the primary channel bandwidth can be 1 MHz, 2 MHz, or 4 MHz. The values of the primary 1 MHz index range from 0 to 7, and the transmission format can be primary (S1G format), duplicate 1 MHz (DUP_1M format), or duplicate 2 MHz (DUP_2M format). FIG. 1 illustrates examples of various channel bandwidths allowed in 8 MHz, 4 MHz, and 2 MHz subbands. There is one primary channel in each channel bandwidth for transmitting frames at that channel bandwidth. The channel corresponding to the entire subband, such as the 8 MHz channel in an 8 MHz subband, does not have a primary designator since there is no secondary channel at that level. A nomenclature for the relative position of channels within the subband is useful, where L represents a lower channel, H represents an upper channel, and primary or secondary is placed in front of these designations. As shown in FIG. 1, there are two 4 MHz channels, primary 4H and secondary 4L, in the 8 MHz subband. There are four 2 MHz channels, primary 2HL, secondary 2HH, 2LH, and 2LL, in the 8 MHz subband. Similarly, there are eight 1 MHz channels in the 8 MHz subband, designated as primary 1HLL, secondary 1HLH, 1HHL, 1HHH, 1LHH, 1LHL, 1LLH, and 1LLL. For a 4 MHz subband, there is either one 4 MHz channel, two 2 MHz channels including primary 2L and secondary 2H, or four 1 MHz channels including primary 1LL, secondary 1LH, 1HL, and 1HH. For a 2 MHz subband, there is either one 2 MHz channel or two 1 MHz channels including primary 1L and secondary 1H.

In some embodiments, the receiver detects one or more subbands based on one or more triggered Short Training Field (STF) correlators. Some duplicate-in-full-band modes and duplicate-in-subband modes have the same operating channel bandwidths and the same primary channel bandwidths; thus, the receiver triggers STF correlators in an identical manner. For example, the 4in4 dup0 (4 MHz non-duplicate mode) has the same operating and primary channel bandwidths as the 4in4 dup1 (duplicate 1 MHz mode) and the 4in4 dup2 (duplicate 2 MHz mode). The classification of these modes, which share the same operating channel bandwidths and primary channel bandwidths, is performed while processing the SIG field of the received wireless frame. The receiver determines the primary channel bandwidth of the received wireless frame based on predefined bits in the SIG field. Based on an analysis of detected subband(s), operating channel bandwidth, power from correlator C1P, power from correlator C1S, energy meter reading, and STF status, the primary channel bandwidth and transmission format of the received vector are determined. Mode classification using time-domain techniques typically involves cross-correlating the STF of the received wireless frame with appropriate kernels and comparing the correlator outputs to generate the classification result. While this time-domain approach has been useful for classifying full-band and subband modes, it has been found to be less effective in classifying duplicate-in-full-band modes (also referred to as duplicate modes) and duplicate-in-subband modes. For example, the classification of two duplicate 1 MHz modes: DUP_1M in 2 in 4 MHz (duplicate-in-subband mode) and DUP_1M in 4 MHz (duplicate mode), has shown inferior detection performance. Similarly, it is difficult to classify three duplicate 1 MHz modes: DUP_1M in 2 in 8 MHz (duplicate-in-subband mode), DUP_1M in 4 in 8 MHz (duplicate-in-subband mode), and DUP_1M in 8 MHz (duplicate mode), using the time-domain approach. The time-domain approach can differentiate these duplicate modes by increasing the number of correlators used for packet detection; however, this escalates hardware complexity, and consequently, increases the cost. For example, for an 8 MHz operating channel bandwidth, the wireless communication device needs additional correlators to distinguish between possible 1 MHz duplicate modes, including full-band and subband duplicate 1 MHz modes. Specifically, the full-band duplicate 1 MHz mode (duplicate mode) includes DUP_1M in 8 MHz, and the subband duplicate 1 MHz modes (duplicate-in-subband modes) include DUP_1 MHz in 2 in 8 MHz and DUP 1 MHz in 4 in 8 MHz. Embodiments of the mode classification method according to the present invention reduce the hardware complexity and the implementation cost.

Embodiments of the mode classification algorithm use frequency-domain techniques to evaluate the configuration of a packet, specifically, whether it is in a 1 MHz subband mode, a duplicate 1 MHz subband mode, or a duplicate 1 MHz full-band mode. The classification challenge in distinguishing a duplicate-in-subband mode (e.g. DUP_1M mode in subband) from a duplicate mode (e.g. DUP_1M mode in full-band) can be resolved by identifying the primary channel bandwidth. The classification algorithm relies on the Fast Fourier Transform (FFT) outputs of four Long Training Field (LTF) symbols. Since these four LTF symbols are identical, some embodiments of the mode classification algorithm compute an average of the FFT outputs from two or more LTF symbols to reduce the effect of noise in the decision statistics. The energy distribution across different subcarriers over the entire operating channel bandwidth is analysed. A well-informed classification of an SIG_1M mode can be achieved by examining the energy distribution across different subbands according to embodiments of the present invention.

Some embodiments of the mode classification method first compute absolute values of the Fast Fourier Transform (FFT) outputs to determine magnitudes of the FFT outputs. In one embodiment of the mode classification algorithm, L1-norm is used to estimate an energy level of each subband by summing the absolute values of the FFT outputs corresponding to subcarriers forming the subband. This approach reduces implementation complexity. In another embodiment, L2-norm is used to calculate an energy level of each subband by summing squared absolute values of the FFT outputs corresponding to subcarriers forming the subband. This approach provides a more accurate representation of the energy level of each subband. To further reduce computational complexity, a magnitude approximation for the magnitude of a complex number I+jQ may be computed according to Equation (1), as described in one embodiment.

$$\vert I + jQ \vert = \vert I \vert + \vert Q \vert + \vert \frac{\vert I \vert - \vert Q \vert}{2} \vert \qquad Equation ( 1 )$$

In this embodiment, the energy in each 1 MHz subband is computed based on the estimated L1-norm energy level. In another embodiment, the energy level in each 1 MHz subband is computed using an alternative energy estimation method. Some embodiments of the mode classification algorithm further compare the computed energy level of each subband with a predetermined threshold and list subband indices of all subbands whose energy levels exceed this predetermined threshold. The list of subband indices is then checked to determine whether the subband indices are consecutive. If these subband indices are consecutive, the number of consecutive 1 MHz subbands can be used to derive the primary channel bandwidth. In cases where only one subband has an energy level exceeding the predetermined threshold, the packet configuration can be declared as a 1 MHz subband case with a primary channel bandwidth of 1 MHz. When multiple consecutive subbands have energy levels exceeding the predetermined threshold, the packet configuration is determined to be either a DUP_1M in subband mode or a full-band DUP_1M mode, with the primary channel bandwidth calculated as 1 MHz multiplied by the number of consecutive subbands exceeding the predetermined threshold.

FIG. 2 presents a flowchart illustrating an embodiment of a mode clarification method designed to distinguish between duplicate modes and duplicate-in-subband modes for a received signal. The flowchart begins with deriving Fast Fourier Transform (FFT) outputs from one or more training symbols carried in the received signal. An example of such training symbols is the Long Training Field (LTF) symbols found in wireless frames compliant with the IEEE 802.11ah standard. In step S202, magnitude values of the FFT outputs are computed. To reduce computational complexity, these magnitude values of each complex number are approximated according to an embodiment. Subsequently, in step S204, these magnitude values are utilized to calculate an energy level of each subband within the operating channel bandwidth. Step S206 involves comparing each subband's energy level against a threshold. In step S208, the indices of subbands with energy levels exceeding this threshold are identified. The method proceeds to step S210, where it checks for multiple consecutive subbands with energy levels above the threshold. If such consecutive subbands are found, step S212 sets the primary channel bandwidth equal to the number of the consecutive subbands with energy levels above the threshold. Conversely, if only a single subband exceeds the threshold in step S210, the primary channel bandwidth is equal to 1 MHz in step S214. Finally, the primary subband index is set to the lowest index among the subbands with energy levels surpassing the threshold. The primary subband index is the start of the subband index in the consecutive subbands with energy levels above the threshold.

FIG. 3 illustrates an embodiment of determining the primary channel bandwidth and the primary subband index. Initially, Fast Fourier Transform (FFT) outputs of the Long Training Field (LTF) symbols, denoted as fft_out_ltf [0] to fft_out_ltf [N−1], undergo magnitude approximation to produce absolute values abs_fft_out_ltf [0] to abs_fft_out_ltf [N−1]. An example of this magnitude approximation is provided in Equation (1). Subsequently, these absolute values are utilized to compute energy levels for S subbands, labelled E₀ to E_{S-1}, within the operating channel bandwidth. Each subband's energy level, Eₖ (where k=0, 1, 2, . . . , S−1), is compared against a threshold. In this embodiment, the threshold is dynamically calculated based on a noise threshold and a scaling factor, allowing it to adapt to changing conditions. Alternatively, a fixed, predefined threshold may be employed according to another embodiment. In certain embodiments, the threshold is initially set according to a noise level and adjusted only if there are significant environmental changes. A counter is incremented for each subband whose energy level is equal to or greater than the threshold. The indices of these subbands are recorded, with the lowest subband index marking the start of the subband sequence. If only one subband's energy level exceeds the threshold, the estimated primary channel bandwidth is set to 1 MHz. Otherwise, the estimated primary channel bandwidth corresponds to the number of recorded subbands, measured in MHz.

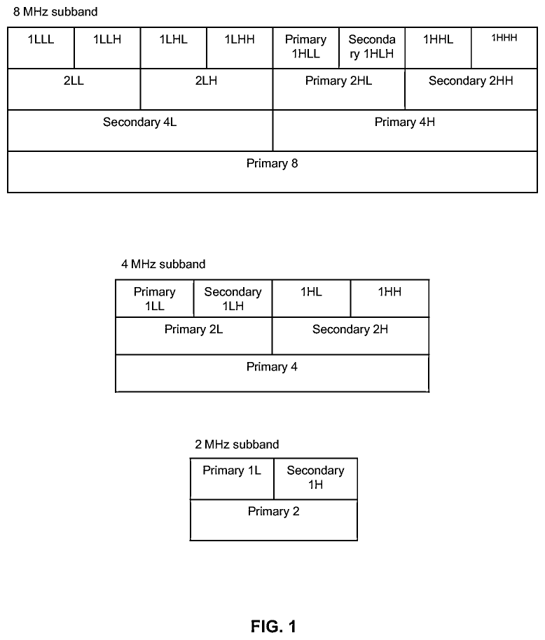

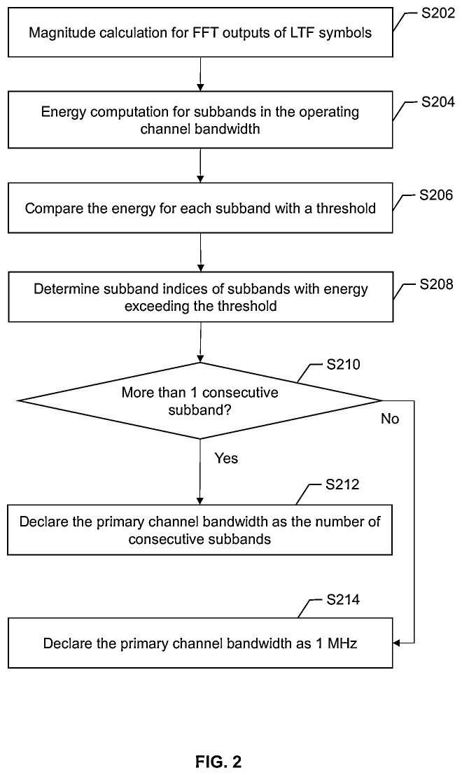

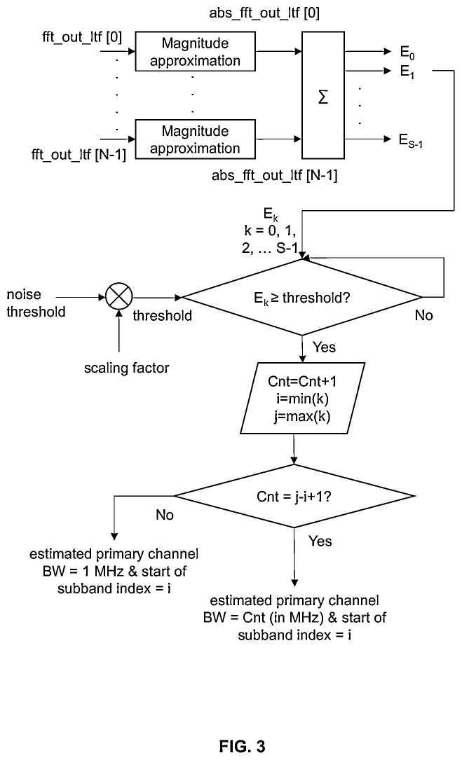

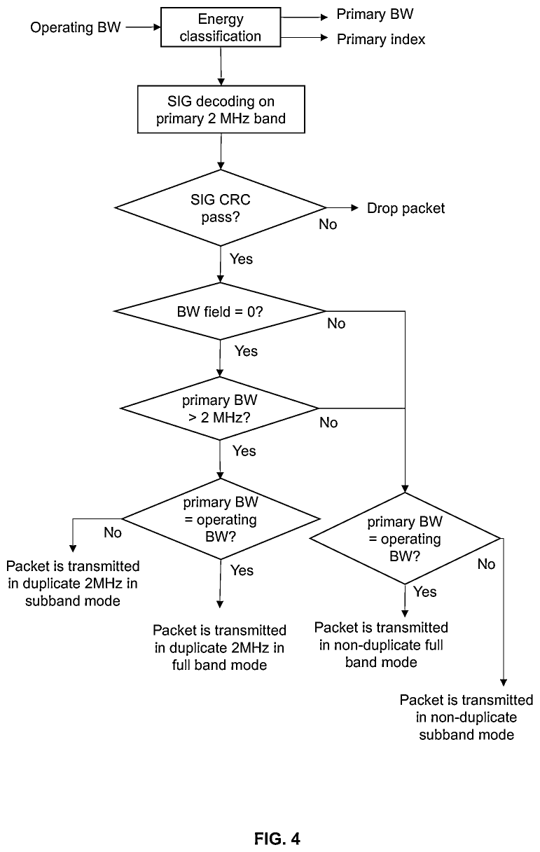

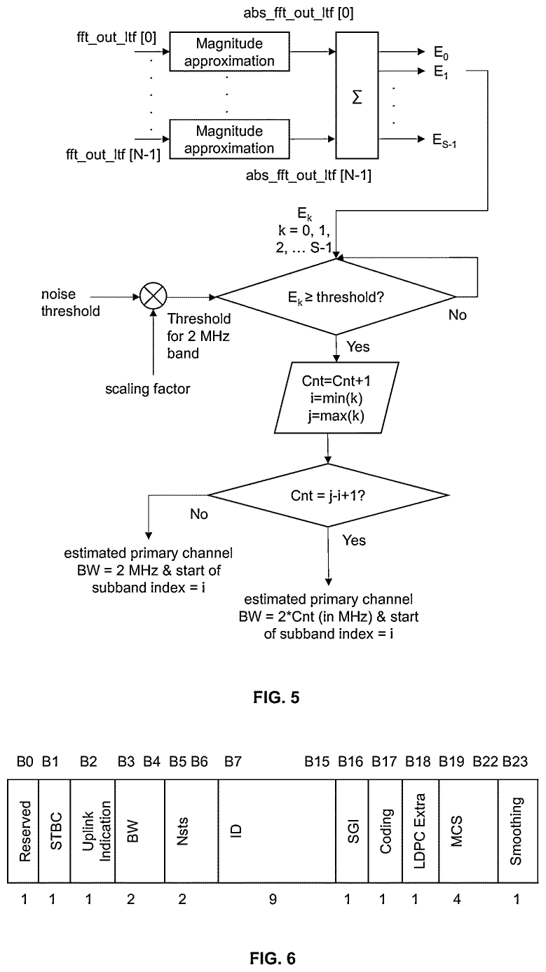

Some embodiments of the present invention not only can classify duplicate 1 MHz modes but are also capable of classifying various duplicate 2 MHz modes. Embodiments of the duplicate mode classification method integrate energy classification with SIGNAL field decoding, such as the SIG-1 field, to determine the duplicate mode used to transmit a packet. In one embodiment, the mode classification method comprises two primary steps. The first step is to detect if the packet is transmitted in a duplicate-in-subband mode or a duplicate mode (i.e. duplicate in full band), and the second step comprises utilizing SIGNAL field decoding to ascertain if it is a duplicate 2 MHz mode, either a DUP_2M mode in subband (duplicate-in-subband mode) or DUP_2M mode in full band (duplicate mode). FIG. 4 illustrates a flowchart of a mode classification method capable of classifying duplicate 2 MHz modes according to an embodiment of the present invention. The first step involves energy classification, where the frequency domain of the received signal is analyzed to identify energy concentrations in 2 MHz-wide subbands, as opposed to the standard 1 MHz subbands. A procedure similar to the mode classification methods depicted in FIGS. 2 and 3 can be employed for this energy classification. FIG. 5 illustrates an embodiment of performing energy classification for the mode classification method that is capable of classifying duplicate 2 MHz modes. The outputs of the first step of the mode classification method are a primary channel bandwidth and a primary subband index. Given that the packet is not transmitted by a 1M mode, FFT outputs of two Long Training Field (LTF) symbols are used for energy classification. The two LTF symbols are the first two symbols following the Short Training Field (STF). Since these LTF symbols are identical, their averaged FFT outputs provide a reliable estimate of the energy distribution across the subbands over the entire operating channel bandwidth. By analyzing the energy distribution across different 2 MHz subbands, a determination can be made regarding the configuration of the S1G packet. For instance, observing the number of consecutive 2 MHz subbands with significant energy levels allows for the deduction of whether the packet was transmitted in a duplicate 2 MHz subband mode or a duplicate 2 MHz full band mode.

To reduce implementation complexity, the energy of the FFT output of the LTF symbols may be estimated using the sum of magnitudes (L1-norm) instead of the more computationally intensive squared sum of magnitudes (L2-norm) according to an embodiment. The threshold for comparing energy levels of the 2 MHz subbands may differ from that used for 1 MHz subbands. In FIG. 3, the estimated primary channel bandwidth output from energy classification for 1 MHz duplicate modes is calculated by multiplying 1 MHz by the number of consecutive subbands with energy levels exceeding the threshold. Similarly, the estimated primary channel bandwidth output from the energy classification process for duplicate 2 MHz modes as shown in FIG. 5 is calculated by multiplying 2 MHz by the number of consecutive subbands with energy levels exceeding the threshold.

The first step, as previously discussed, involves analyzing the LTF to estimate a primary channel bandwidth and identify a primary subband index. The second step of the mode classification method capable of determining duplicate 2 MHz modes includes SIGNAL field decoding as shown in FIG. 4. After determining the primary channel bandwidth and primary subband index from the first step, the second step involves decoding the SIGNAL field, such as the SIG-1 field of the received frame, to confirm the specific transmission mode. The SIGNAL field decoding is done on the primary 2 MHz subband detected based on the primary subband index determined in the first step. This SIGNAL field decoding step verifies whether the packet is operating in a duplicate 2 MHz mode within a subband or across the full band, ensuring accurate mode classification. FIG. 6 illustrates a syntax structure of a signal field (SIG) SIG-1 carried in a wireless frame in compliance with the Wi-Fi HaLow standard. As depicted in FIG. 6, the SIG-1 field structure includes a bandwidth field located at bits 3 and 4. After successfully passing the Cyclic Redundancy Check (CRC) of the SIGNAL field, the bandwidth (BW) field is examined to decipher if the packet was sent in a duplicate 2 MHz mode. The packet is dropped if the CRC of the SIG field fails.

As shown in FIG. 4, if the bandwidth field in the SIGNAL field is set to 0 and the estimated primary channel bandwidth is greater than 2 MHz but does not match the operating bandwidth, the packet is considered to be transmitted in a duplicate 2 MHz subband mode (i.e., a duplicate in subband mode). Conversely, if the estimated primary channel bandwidth is greater than 2 MHz and matches the operating channel bandwidth, and the bandwidth field is 0, the packet is identified as being transmitted in a duplicate 2 MHz full band mode (i.e., a duplicate in full band mode). In these scenarios where duplicate mode is detected, the demodulator is reconfigured to operate in a duplicate mode. In cases where the bandwidth field is 0 and the primary channel bandwidth is not greater than 2 MHz, the packet is classified as being transmitted in a non-duplicate mode. For example, when the estimated primary channel bandwidth is 2 MHz and the bandwidth field is 0, the packet is classified as a 2 MHz non-duplicate subband mode when the operating channel bandwidth is greater than 2 MHz, and as a 2 MHz non-duplicated full band mode when the operating channel bandwidth is equal to 2 MHz. On the other hand, if the bandwidth field in the SIGNAL field is non-zero, it signifies that the packet was transmitted either in full band or subband mode without duplication. In such cases, if the primary channel bandwidth equals the operating channel bandwidth, the packet is declared to be transmitted in a non-duplicate full band mode. Otherwise, it is classified as a non-duplicate subband mode. It is important to note that when the operating bandwidth is 4 MHz, 8 MHz or 16 MHz, the transmitted STF portions are repetitions of the 2 MHz STF in the frequency domain. However, the LTFs of signals transmitted in 4 MHz, 8 MHz or 16 MHz modes are different from those of a duplicate 2 MHz case in these bandwidths, wherein the LTF of the duplicate 2 MHz signal consists of repetitions of the 2 MHz LTFs in the frequency domain. Since the signal can be completely classified as a duplicate 2 MHz signal or a non-duplicate signal at the end of SIG field decoding, it is important to store two sets of channel estimates. One set assumes a duplicate 2 MHz full band mode and the other set assumes a non-duplicate full band mode. This ensures that the correct channel estimates are used for payload decoding for either a duplicate 2 MHz or a non-duplicate signal. The demodulator is reconfigured to operate in a duplicate mode if the determined mode is a duplicate full band mode or a duplicate subband mode. Upon determining the mode is a subband mode (i.e., the duplicate subband mode or non-duplicate subband mode), appropriate subcarriers from the corresponding full band channel estimate are selected based on the estimated primary channel bandwidth and the primary subband index.

The following demonstrates an analysis of probability of detection in an Additive White Gaussian Noise (AWGN) channel. The FFT output

$${Y}_{k}^{( i )}$$

on the K^{th} sub-carrier corresponding to the i^{th} LTF symbol is represented by Equation (2). For example, there are 64 sub-carriers in a 2 MHz subband.

$${Y}_{k}^{( i )} = {X}_{k} + {X}_{k}^{( i )} , k = 0 , 1 , ... , {N}_{FFT} - 1 ; \qquad Equation ( 2 )$$

where Xₖ is the reference LTF symbol on the K^{th} sub-carrier and

$${X}_{k}^{( i )}$$

represents the complex Gaussian noise with zero mean and variance σ². Note that, Xₖ can take values of ±α or 0 in cases where there is no transmission in unused subbands. If LTF symbols are used to average the FFT output, the averaged FFT output is:

$$\begin{matrix}{Y}_{k}^{avg} = \frac{1}{L} {\sum }_{i = 0}^{L - 1} & {Y}_{k}^{( i )} = {X}_{k} + {N}_{k}^{avg} , k = 0 , 1 , … , {N}_{FFT} - 1 ;\end{matrix} \qquad Equation ( 3 )$$

where

$${Y}_{k}^{avg}$$

is a complex Gaussian random variable with zero mean and variance equals to

$$\frac{{σ}^{2}}{L} .$$

Note that for sub-carriers where there is no transmitted data (unused sub-carriers), i.e. Xₖ=0,

$${Y}_{k}^{avg} = {N}_{k}^{avg} , else {Y}_{k}^{avg}$$

is a complex. Gaussian random variable with mean equal to ±α and variance equals to

$$\frac{{σ}^{2}}{L} .$$

Two random variables Sₖ and Iₖ are defined in Equations (4) and (5).

$${S}_{k} = {X}_{k} + {N}_{k}^{avg} , k ϵ used sub - carriers ; \qquad Equation ( 4 )$$

$${I}_{k} = {N}_{k}^{avg} , k ϵ unused sub - carriers ; \qquad Equation ( 5 )$$

it is observed that an absolute value of the variable |Sₖ| is a Rician random variable with mean and variable given by Equations (6), (7), and (8).

$$E [ \vert {S}_{k} \vert ] = \frac{σ}{\sqrt{2 L}} \sqrt{\frac{π}{2}} {e}^{\frac{- k}{2}} [ ( 1 + K ) {I}_{0} ( \frac{K}{2} ) + {KI}_{1} ( \frac{K}{2} ) ] \qquad Equation ( 6 )$$

$$E [ {\vert {S}_{k} \vert}^{2} ] = \frac{{σ}^{2}}{L} + {s}^{2} \qquad Equation ( 7 )$$

$$var [ \vert {S}_{k} \vert ] = E [ {\vert {S}_{k} \vert}^{2} ] - {\{ E [ {S}_{k} ] \}}^{2} \qquad Equation ( 8 )$$

where s=|a|,

$$K = \frac{{s}^{2} L}{{σ}^{2}} . {I}_{0} ( . )$$

and I₁(·) represent modified Bessel functions of zero and first order.
It can also be seen that |Iₖ| is a Rayleigh random variable with mean and variance given by Equations (9) and (10).

$$E [ \vert {I}_{k} \vert ] = \frac{σ}{\sqrt{2 L}} \sqrt{\frac{π}{2}} \qquad Equation ( 9 )$$

$$var [ \vert {S}_{k} \vert ] = ( 2 - \frac{π}{2} ) \frac{{σ}^{2}}{2 L} \qquad Equation ( 10 )$$

The energy in a used or occupied subband is represented in Equation (11), and the energy in an unused subband is represented in Equation (12).

$${E}_{sub}^{used} = {\sum }_{k = 0}^{{N}_{sc , 1 MHz - 1}} \vert {S}_{k} \vert \qquad Equation ( 11 )$$

$${E}_{sub}^{unused} = {\sum }_{k = 0}^{{N}_{sc , 1 MHz - 1}} \vert {I}_{k} \vert \qquad Equation ( 12 )$$

where N_{sc,1 MHz-1} represents the number of used sub-carriers in a 1 MHz subband, for example, the number of used sub-carriers in a 1 MHz subband is at least 20. Note that by invoking the central-limit theorem, the energy in a used subband can be approximated as a Gaussian random variable with mean and variance equal to N_{sc,1 MHz-1} E[|Sₖ|] and N_{sc,1 MHz-1}var [|Sₖ|] respectively. Similarly, the energy in an unused subband can be approximated as a Gaussian random variable with mean and variance equal to N_{sc,1 MHz-1} E[|Iₖ|] and N_{sc,1 MHz-1}var [|Iₖ|] respectively.

The probability of detection P_{d} is given by Equation (13).

$${P}_{d} = prob \cdot ( \{ {E}_{sub}^{used} in all used subbands > γ \} ⋂ \{ {E}_{sub}^{unused} in all unused subbands < γ \} ) ; \qquad Equation ( 13 )$$

where γ is a predetermined threshold.
Let Nₐ be the number of available 1 MHz subbands in the operating channel bandwidth and Nᵤ be the number of used 1 MHz subbands. The probability of detecting the energy of a used subband is:

$$prob \cdot ( {E}_{sub}^{used} > γ ) = Q ( \frac{γ - {μ}_{1}}{{σ}_{1}} ) ; \qquad Equation ( 14 )$$

where Q(x) represents the tail distribution function of a standard Gaussian random variable, and μ₁=N_{sc,1 MHz-1}E[|Sₖ|] and σ₁=\sqrt{N_{sc,1 MHz-1}var[|Sₖ|]}.
Similarly, the probability of detecting the energy of an unused subband is:

$$prob \cdot ( {E}_{sub}^{unused} \leq γ ) = 1 - Q ( \frac{γ - {μ}_{2}}{{σ}_{2}} ) ; \qquad Equation ( 15 )$$

where μ₂=N_{sc,1 MHz-1}E[|Iₖ|] and σ₂=\sqrt{N_{sc,1 MHz-1}var[|Iₖ|]}.
According to Equation (14) and Equation (15), the probability of detection P_{d} is:

$${P}_{d} = {{[ Q ( \frac{γ - {μ}_{1}}{{σ}_{1}} ) ]}^{{N}_{u}} [ 1 - Q ( \frac{γ - {μ}_{2}}{{σ}_{2}} ) ]}^{{N}_{a} - {N}_{u}} .$$

A wireless device implementing one or more embodiments of the mode classification algorithm manages the Media Access Control (MAC) layer and the Physical (PHY) layer in accordance with the Wi-Fi HaLow (IEEE 802.11ah) standard or other wireless communication protocol employing duplicate modes. The wireless device comprises a Radio Frequency (RF) transmitter, an RF receiver, an antenna, one or more memory banks, input and output interfaces, and a communication bus. The RF transmitter modulates one or more carrier wave signals to encode digital information for transmission, while the RF receiver demodulates incoming signals to reconstruct the original digital information. The device may include a MAC processor, a PHY processor, and a HOST processor. The memory stores software programs that implement functions of the MAC layer. The processors execute software programs to perform the functions of its respective communication or application layer. For example, the PHY processor manages the interface with the wireless medium. The MAC processor executes MAC-level instructions and manages the interface between the application software and the wireless medium through the PHY processor.

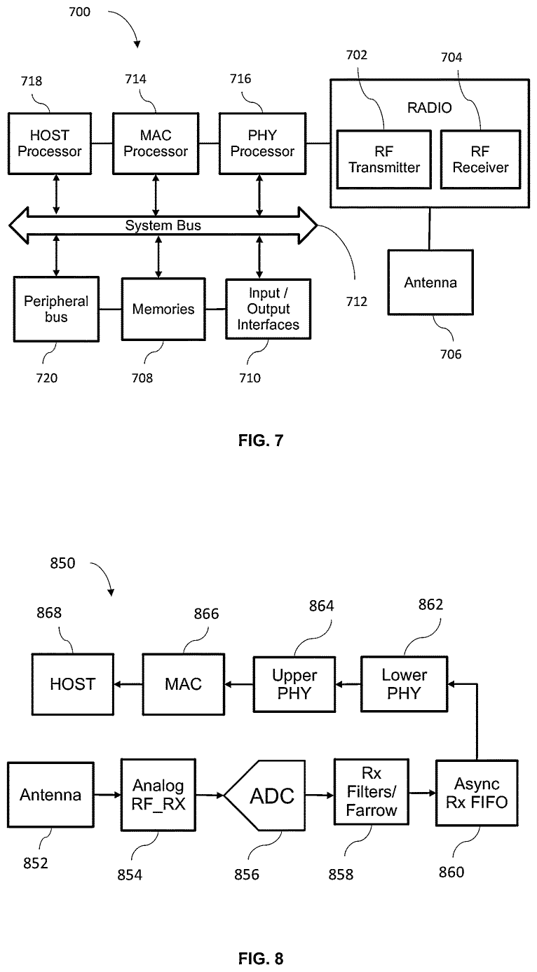

FIG. 7 shows a high-level block diagram of a wireless communication device 700 that can be used to implement an embodiment of the mode classification method. For example, the wireless communication device 700 manages an MAC layer and a PHY layer in compliance with one or more wireless protocols employing various duplicate modes. The wireless communication device 700 is a Station (STA) or an Access Point (AP) of a wireless network. For example, the wireless communication device 700 can be included in a mobile device, a personal computer, a laptop computer, an Internet of Things (IoT) device, a wearable device, an extended reality device, a video server, a camera, or a communication device on a vehicle. The wireless communication device 700 includes an RF transmitter module 702, an RF receiver module 704, an antenna unit 706, one or more memory banks 708, input and output interfaces 710 and communication bus 712. The RF transmitter module 702 and the RF receiver module 704 are also known as an RF transceiver, or a modem (modulator-demodulator), which transmits frames by modulating one or more carrier wave signals to encoded digital information, as well as receives frames by demodulating the signal to reconstruct the original digital information. Furthermore, the wireless communication device 700 includes a MAC processor 714, a PHY processor 716, and a HOST processor 718. These processors can be realized by any type of Integrated Circuit (IC) such as a General Processing Unit (GPU), an Application Specific Integrated Circuit (ASIC), or Reduced Instruction Set Computer-Five (RISC-V) based ICs, amongst others. Memory banks 708 store software codes for the processors of the wireless communication device 700. Each processor executes software to implement the functions of the respective communication or application layer. The PHY processor 716 includes a transmitting signal processing unit and a receiving signal processing unit and manages the interface with the wireless medium. The PHY processor 716 operates on PPDUs by exchanging digital samples with the radio module which comprises the RF transmitter 702, Digital-to-Analog Converters (DACs), the RF receiver 704, Analog-to-Digital Converters (ADCs) and digital filters. The MAC processor 714 executes MAC level instructions and manages the interface between the application software and the wireless medium, through the PHY processor 716. The MAC processor 714 is responsible for coordinating access to the wireless medium so that the AP and STAs in range can communicate effectively. The MAC processor 714 adds header and tail bytes to units of data provided by the higher levels and sends them to the PHY layer for transmission. The reverse happens when receiving data from the PHY layer. If a wireless frame is received in error, the MAC processor 714 manages the retransmission of the wireless frame. The HOST processor 718 interfaces with the MAC layer and is responsible for running high level functionalities of the wireless communication device 700.

The peripheral bus 720 connects to a number of peripherals that support core functions of the wireless communication device 700, these peripherals may include timers, interrupts, radio/filters/system registers, counters, Universal Asynchronous Receiver-Transmitter (UART), General Purpose Input Output (GPIO) interfaces and others. The PHY processor 716, the MAC processor 714, the HOST processor 718, the peripheral bus 720, memory banks 708 and input/output interfaces 710, communicate with each other via the system bus 712. Memory banks 708 may further store an operating system and applications. The input/output interface unit 710 allows for the exchange of information with a user. The antenna unit 706 may include a single antenna or multiple antennas.

FIG. 8 illustrates a schematic block diagram of a receiver data flow architecture 850 that can be used to receive wireless signals carrying frames over the wireless medium. In one illustrative embodiment, the receiver data flow architecture 850 illustrated in FIG. 8 corresponds to or otherwise be associated with the wireless communication device 700 illustrated in FIG. 7. In some embodiments, wireless signals are received over the wireless medium and transformed into electrical Radio Frequency (RF) signals by a receiving antenna 852. A RF receiver front-end 854 receives an electrical RF signal carrying Wi-Fi frames. The RF receiver front-end 854 may contain a Low Noise Amplifier (LNA), a mixer for down converting the RF signal to an Intermediate Frequency (IF) or baseband signal based on a Local Oscillator (LO) signal, and a Trans-Impedance Amplifier (TIA). An Analog-to-Digital Converter (ADC) 856 coupled to the RF receiver front-end 854 transforms the baseband signal from analog to digital. The output of the ADC 856 is connected to a receiver down-sampling chain 858 (Rx Filters/Farrow), samples are then collected in an asynchronous receiving First In First Out (FIFO) structure 860. These samples in the asynchronous receiving FIFO structure can be accessed by a packet detect module and a sub-band module, both of which may be included in a lower-level PHY module 862. The packet detect module includes hardware and/or implement algorithms that can be used to analyze the preamble of the PHY Protocol Data Unit (PPDU) in the time domain. Upon successful packet detection, the packet detect module recognizes a received IEEE 802.11 frame and synchronizes the frequency and timing of the wireless communication device with the frame being received. The sub-band module within the lower-level PHY module 862 includes hardware and/or implement algorithms that can be used to detect which subchannel in the allocated frequency band is being used for the packet being received. Once a packet is detected and the relevant subchannel is established, samples are forwarded to an upper-level PHY module 864. The upper-level PHY module 864 together with the lower-level PHY module 862 are included in the PHY processor 716 illustrated in FIG. 7. In some embodiments, the upper-level PHY module 864 can be used to process and decode Orthogonal Frequency Division Multiplexing (OFDM) symbols, with the support of a coprocessor module, to reconstruct a full PPDU. The reconstructed PPDU is output by the upper-level PHY module 864 and subsequently processed by a MAC layer processor 866. MAC layer processor 866 is used to extract the data payload from the PPDU and provide the relevant information to the HOST layer 868 for consumption.

Although the invention is illustrated and described herein with reference to specific embodiments, the invention is not intended to be limited to the details shown. Rather, various modifications may be made in the details within the scope and range of equivalents of the claims and without departing from the invention. It is to be understood that the above description is illustrative of the invention and is not to be construed as limiting the invention. Various modifications, applications and/or combinations of the embodiments may occur to those skilled in the art without departing from the scope of the invention as defined by the claims. Well-known circuits, processes, algorithms, structures, and techniques may be shown without unnecessary detail to avoid obscuring the aspects.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks may be stored in a computer-readable or machine-readable medium. The computer-readable medium may comprise memory or data storage media, such as Random-Access Memory (RAM) such as Synchronous Dynamic Random-Access Memory (SDRAM), Read-Only Memory (ROM), Non-Volatile Random-Access Memory (NVRAM), Electrically Erasable Programmable Read-Only Memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves. The program code may be executed by a processor, which may include one or more processors, such as one or more Digital Signal Processors (DSPs), general purpose microprocessors, an Application Specific Integrated Circuits (ASICs), Field Programmable Logic Arrays (FPGAs), or other equivalent integrated or discrete logic circuitry. Such a processor may be configured to perform any of the steps described in this disclosure. A general-purpose processor may be a microprocessor; alternatively, the processor may be any conventional processor, controller, microcontroller, or state machine. A processor may also be implemented as a combination of computing devices.

To clearly illustrate the interchangeability of hardware and software, various illustrative components, blocks, modules, engines, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present application.

What is claimed is:

1. A mode classification method performed by a wireless communication device operating in a wireless network, the method comprising:
receiving a wireless frame transmitted over an operating channel bandwidth;
determining a frequency domain signal representing a plurality of symbols carried in the wireless frame;
estimating a primary channel bandwidth for the wireless frame from the frequency domain signal;
determining a bandwidth field in a signal field (SIG) of the wireless frame;
comparing the primary channel bandwidth with the operating channel bandwidth;
and
determining a mode used to transmit the wireless frame based on the bandwidth field and the comparing result, wherein the wireless frame is processed according to the determined mode.

2. The mode classification method of claim 1, wherein the mode is determined from a non-duplicate subband mode, a non-duplicate full band mode, a duplicate subband mode, and a duplicate full band mode.

3. The mode classification method of claim 2, further comprises comparing the primary channel bandwidth with 2 MHz, wherein the mode used to transmit the wireless frame is determined to be the duplicate subband mode or the duplicate full band mode when the primary channel bandwidth is greater than 2 MHz, and the mode is determined to be the non-duplicate subband mode or the non-duplicate full band mode when the primary channel bandwidth is not greater than 2 MHz.

4. The mode classification method of claim 3, wherein the bandwidth field is determined to be zero, wherein the mode is determined to be the duplicate subband mode when the primary channel bandwidth is greater than 2 MHz but not equal to the operating channel bandwidth; the mode is determined to be the duplicate full band mode when the primary channel bandwidth is greater than 2 MHz and is equal to the operating channel bandwidth; the mode is determined to be the non-duplicate subband mode when the primary channel bandwidth is not greater than 2 MHz and is not equal to the operating channel bandwidth, and the mode is determined to be the non-duplicate full band mode when the primary channel bandwidth is not greater than 2 MHz but is equal to the operating channel bandwidth.

5. The mode classification method of claim 4, wherein the mode is determined to be the non-duplicate subband mode when the primary channel bandwidth is equal to 2 MHz but not equal to the operating channel bandwidth, and the mode is determined to be the non-duplicate full band mode when both the primary channel bandwidth and operating channel bandwidth are equal to 2 MHz.

6. The mode classification method of claim 2, wherein upon determining the bandwidth field is non-zero, the mode used to transmit the wireless frame is determined to be the non-duplicate subband mode when the primary channel bandwidth is not equal to the operating channel bandwidth, and the mode is determined to be the non-duplicate full band mode when the primary channel bandwidth is equal to the operating channel bandwidth.

7. The mode classification method of claim 1, wherein determining a frequency domain signal comprises transforming Long Training Field (LTF) symbols from a time domain to a frequency domain based on a Fast Fourier Transform (FFT).

8. The mode classification method of claim 1, wherein the step of estimating a primary channel bandwidth comprises:
calculating magnitudes of the frequency domain signal;
computing energy levels corresponding to a plurality of subbands in the operating channel bandwidth;
comparing the energy levels with a threshold; and
estimating the primary channel bandwidth according to a number of consecutive subbands with energy levels exceeding the threshold.

9. The mode classification method of claim 8, wherein the step of calculating magnitudes of the frequency domain signal further comprises computing an average of FFT outputs of LTF symbols carried in the wireless frame.

10. The mode classification method of claim 8, wherein the step of calculating magnitudes of the frequency domain signal comprises approximating the magnitude of each complex number (I+jQ) by summing an absolute value of I, an absolute value of Q, and a half of a difference between the two absolute values, wherein I represents an in-phase component of the complex number and Q represents a quadrature phase component of the complex number.

11. The mode classification method of claim 8, wherein the step of computing energy levels corresponding to a plurality of subbands comprises estimating an energy level for each subband by summing absolute values of sub-carriers forming the subband.

12. The mode classification method of claim 8, wherein the step of computing energy levels corresponding to a plurality of subbands comprises estimating an energy level for each subband by summing squared absolute values of sub-carriers forming the subband.

13. The mode classification method of claim 8, further comprises determining a subband index of a lowest subband with an energy level exceeding the threshold.

14. The mode classification method of claim 8, further comprises checking if subband indices of subbands with energy levels exceeding the threshold are consecutive.

15. The mode classification method of claim 14, wherein each of the subbands is 1 MHz, the primary channel bandwidth is 1 MHz when there is only one subband with an energy level exceeding the threshold, and the primary channel bandwidth is equal to 1 MHz multiplying the number of consecutive subbands when there are two or more consecutive subbands with energy levels exceeding the threshold.

16. The mode classification method of claim 14, wherein each of the subband is 2 MHz, the primary channel bandwidth is 2 MHz when there is only one subband with an energy level exceeding the threshold, and the primary channel bandwidth is equal to 2 MHz multiplying the number of consecutive subbands when there are two or more consecutive subbands with energy levels exceeding the threshold.

17. The mode classification method of claim 1, wherein two sets of channel estimates are stored, one set assuming a duplicate 2 MHz full band mode signal and another set assuming a non-duplicate full band mode signal, the mode classification method further comprises selecting one set of channel estimates based on the determined mode to decode payload of the wireless frame.

18. The mode classification method of claim 17, wherein further comprises selecting subcarriers from the selected set of channel estimates based on the primary channel bandwidth and a subband index when the determined mode is a subband mode.

19. The mode classification method of claim 1, further comprising reconfiguring a demodulator to operate in a duplicate mode when the determined mode is a duplicate full band mode or a duplicate subband mode.

20. A wireless communication device operating in a wireless network, comprising:
a Radio Frequency (RF) receiver receiving a wireless frame transmitted over an operating channel bandwidth;
a processor, communicatively coupled to the RF receiver;
one or more memory banks, communicatively coupled to the processor and storing processor readable codes that, when executed by the processor, are configured for:
determining a frequency domain signal representing a plurality of symbols carried in the wireless frame;
estimating a primary channel bandwidth for the wireless frame from the frequency domain signal;
determining a bandwidth field in a signal field (SIG) of the wireless frame;
comparing the primary channel bandwidth with the operating channel bandwidth;
and
determining a mode used to transmit the wireless frame based on the bandwidth field and the comparing result; and
a demodulator, operating in a duplicate mode when the determined mode is a duplicate full band mode or a duplicate subband mode.
